(19) United States
(12) Patent Application Publication
(10) Pub. No.: US 2026/0051696 A1
(43) Pub. Date: Feb. 19, 2026

(54) ELECTRICAL CONNECTOR

(71) Applicant: MITSUMI ELECTRIC CO., LTD., Tokyo (JP)

(72) Inventors: Takahiro AKAIKE, Tokyo (JP); Takashi KAWASAKI, Tokyo (JP)

(21) Appl. No.: 19/283,902

(22) Filed: Jul. 29, 2025

(30) Foreign Application Priority Data
Aug. 13, 2024 (JP) 2024-134770

(51) Int. Cl. H01R 13/58; H01R 4/18; H01R 24/40

(52) U.S. Cl. CPC H01R 13/58; H01R 4/185; H01R 24/40

(57) ABSTRACT

An electrical connector includes a contact pin to be connected to a core wire of a coaxial cable, an insulating housing for holding the contact pin therein, a cylindrical outer contact covering the housing, an inner crimping member to be crimped onto the outer conductor layer of the coaxial cable, and an outer crimping member integrated with the outer contact and crimped onto the inner crimping member from an outer side. A locking protrusion of the outer crimping member is in contact with a base end surface of the inner crimping member from a base side.

### CROSS-REFERENCE TO RELATED APPLICATION

The present application claims priority from Japanese Patent Application No. 2024-134770, filed Aug. 13, 2024. The entire contents of the above-listed application are hereby incorporated by reference for all purposes.

### TECHNICAL FIELD

The present disclosure generally relates to electrical connectors, in particular to an electrical connector used for providing a coaxial connection with a coaxial cable.

### BACKGROUND ART

In order to provide an electrical connection between an electronic device and another electronic device through a cable, a combination of a receptacle connector and a plug connector has been widely used. Further, an amount of data transmitted from the electronic device to the other electronic device through the cable has increased as processing capacities of electronic devices have been improved in recent years. In order to transmit a large amount of data in a short time, it is necessary to transmit a high frequency signal through the cable. Thus, there are needs of improving signal transmission characteristics of the cable, particularly, signal transmission characteristics of the cable in a high frequency band. In order to address such needs, a coaxial cable having high signal transmission characteristics in the high frequency band has been widely used. As is well known, the coaxial cable has a coaxial structure in which a core wire for transmitting a signal, an inner insulator layer covering the core wire from an outer side, an outer conductor layer (a braid layer) covering the inner insulator layer from the outer side, and an outer insulator layer (a sheath) covering the outer conductor layer from the outer side are concentrically arranged.

In order to provide a coaxial connection with the above-mentioned coaxial cable, there has been widely used an electrical connector including a contact pin (an inner contact) to be electrically connected to the core wire of the coaxial cable, an insulating housing covering the contact pin, and an outer contact covering the housing and electrically connected to the outer conductor layer of the coaxial cable. For example, patent document 1 discloses an electrical connector 500 shown in FIG. 1. FIG. 1 is a partial cross-sectional view of the electrical connector 500. The electrical connector 500 should be connected to an end portion of a coaxial cable 600 including a core wire 610, an inner insulator layer 620, an outer conductor layer 630, and an outer insulator layer 640.

The electrical connector 500 includes a metal contact pin 510 to be crimped onto the core wire 610, a metal inner crimping member 520 to be crimped onto the outer conductor layer 630, an insulating housing (not shown) for holding the contact pin 510 therein, a metal outer contact 530 for holding the housing therein, and a metal outer crimping member 540 formed integrally with the outer contact 530 and crimped onto the inner crimping member 520. The outer contact 530 is attached to the coaxial cable 600 by crimping the outer crimping member 540, which is integrated with the outer contact 530, from the outer side onto the inner crimping member 520, which is crimped onto the outer conductor layer 630.

As shown in FIG. 2, the outer crimping member 540 includes a cylindrical portion 550, a pair of opposite end surfaces 560 whose separation distance increases from a tip side toward a base side and that is formed on the cylindrical portion 550, concave and convex structures 570 respectively formed on the pair of opposite end surfaces 560 so as to complementarily engage with each other, and a cantilever-shaped locking piece 580 formed by cutting and raising the cylindrical portion 550 toward the inner side. FIG. 3 is a partial cross-sectional view for explaining locking of the inner crimping member 520 by the outer crimping member 540 from the base side. As shown in FIG. 3, in an assembled state of the electrical connector 500, the locking piece 580 of the outer crimping member 540 faces a base end surface of the inner crimping member 520. In this state, when a pulling operation toward the base side is applied to the coaxial cable 600, the locking piece 580 is in contact with the base end surface of the inner crimping member 520, thereby preventing the coaxial cable 600 from being removed from the electrical connector 500 to the base side. With this configuration, it is possible to improve pull-out strength of the electrical connector 500 with respect to the pulling operation applied to the coaxial cable 600.

When the electrical connector 500 is assembled, the coaxial cable 600 onto which the inner crimping member 520 is crimped is inserted into the outer crimping member 540 from the base side. Then, by closing the pair of opposite end surfaces 560 so that the concave and convex structures 570 of the pair of opposite end surfaces 560 are complementarily engaged with each other, the outer crimping member 540 is crimped onto the inner crimping member 520. When the coaxial cable 600 is inserted into the outer crimping member 540 from the base side, the locking piece 580 is elastically deformed toward the outer side by the inner crimping member 520 and slides on the inner crimping member 520. After that, when the inner crimping member 520 passes over the locking piece 580, the locking piece 580 is elastically restored toward the inner side. When the locking piece 580 slides on the inner crimping member 520, an edge portion of the locking piece 580 is shaved by the inner crimping member 520, thereby generating metal shavings inside the outer crimping member 540. Such shavings may cause a short circuit (a short) in the electrical connector 500, thereby reducing connection reliability of the electrical connector 500.

Further, when the coaxial cable 600 is inserted into the outer crimping member 540 from the base side, the locking piece 580 is elastically deformed toward the outer side by the inner crimping member 520. Since the locking piece 580 has a cantilever shape, when the locking piece 580 is elastically deformed toward the outer side, a strong load is concentrated on a fixed end of the locking piece 580, that is, a connection portion between the locking piece 580 and the cylindrical portion 550, thereby causing permanent deformation (permanent setting) at the connection portion. As a result, a contact area between the locking piece 580 and the base end surface of the inner crimping member 520 is reduced, and thereby the pull-out strength of the electrical connector 500 with respect to the pulling operation applied to the coaxial cable 600 becomes insufficient.

### RELATED ART DOCUMENTS

### Patent documents

Patent document 1: U.S. Pat. No. 11,677,166 B2

### SUMMARY OF THE DISCLOSURE

### Problem to be Solved by the Disclosure

The present disclosure has been made in view of the above-mentioned problem. Accordingly, it is an object of the present disclosure to provide an electrical connector that has excellent pull-out strength with respect to the pulling operation applied to the coaxial cable and can prevent the generation of shavings inside the outer crimping member.

### Means for Solving the Problem

The above object is achieved by the present disclosure defined by the following (1).

(1) An electrical connector to be coupled with a coaxial cable including a core wire, an inner insulator layer covering the core wire, an outer conductor layer covering the inner insulator layer, and an outer insulator layer covering the outer conductor layer, the electrical connector comprising:
a contact pin to be connected to the core wire of the coaxial cable;
an insulating housing for holding the contact pin therein;
a cylindrical outer contact for covering the housing;
an inner crimping member to be crimped onto the outer conductor layer of the coaxial cable; and
an outer crimping member integrated with the outer contact and crimped onto the inner crimping member from an outer side,
wherein the outer crimping member includes:
   a cylindrical crimping portion crimped onto the inner crimping member from the outer side, and
   a locking protrusion protruding from an inner peripheral surface of the crimping portion toward an inner side, and
wherein the locking protrusion of the outer crimping member is in contact with a base end surface of the inner crimping member from a base side.

### Effects of the Disclosure

In the electrical connector of the present disclosure, the locking protrusion of the outer crimping member is in contact with the base end surface of the inner crimping member from the base side, thereby preventing the coaxial cable from being removed from the electrical connector to the base side when the pulling operation is applied to the coaxial cable. Further, when the coaxial cable onto which the inner crimping member is crimped is inserted into the outer crimping member, permanent deformation (permanent setting) of the locking protrusion does not occur. Thus, since a contact area between the locking protrusion and the base end surface of the inner crimping member is not reduced, the pull-out strength of the electrical connector with respect to the pulling operation on the coaxial cable can be improved.

Further, when the coaxial cable is inserted into the outer crimping member, the locking protrusion of the outer crimping member is not shaved by the inner crimping member. Therefore, it is possible to prevent generation of shavings inside the outer crimping member, thereby improving connection reliability of the electrical connector.

### BRIEF DESCRIPTION OF THE FIGURES

FIG. 1 is a partial cross-sectional view of a conventional electrical connector.

FIG. 2 is a planar view of an outer crimping member of the electrical connector shown in FIG. 1.

FIG. 3 is a partial cross-sectional view for explaining locking of an inner crimping member from the base side by the outer crimping member of the electrical connector shown in FIG. 1.

FIG. 4 is a perspective view showing an electrical connector of the present disclosure and a coaxial cable to which the electrical connector is connected.

FIG. 5 is an exploded perspective view of the electrical connector and the coaxial cable shown in FIG. 4.

FIG. 6 is a cross-sectional view of the electrical connector and the coaxial cable in a plane containing one of core wires of the coaxial cable.

FIG. 7 is a perspective view of an inner crimping member shown in FIG. 5 viewed from another angle.

FIG. 8 is a perspective view of a contact pin shown in FIG. 5 viewed from another angle.

FIG. 9 is a perspective view of a housing shown in FIG. 5 viewed from another angle.

FIG. 10 is a cross-sectional view for explaining holding of the contact pins in the housing.

FIG. 11 is a perspective view of an outer contact shown in FIG. 5 viewed from another angle.

FIG. 12 is a planar view showing the outer crimping member before being crimped onto the inner crimping member.

FIG. 13 is a perspective view for explaining crimping of the outer crimping member onto the inner crimping member.

FIG. 14 is a perspective view of a locking protrusion of the outer crimping member shown in FIG. 12.

FIG. 15 is a cross-sectional view for explaining locking of the inner crimping member in the outer crimping member by the locking protrusion.

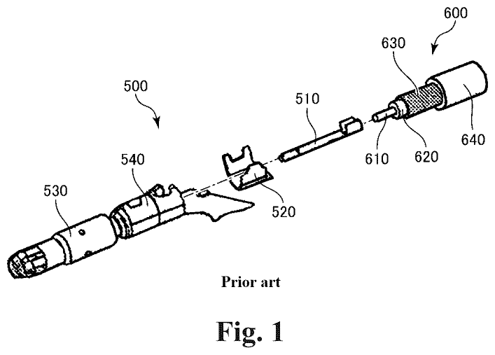

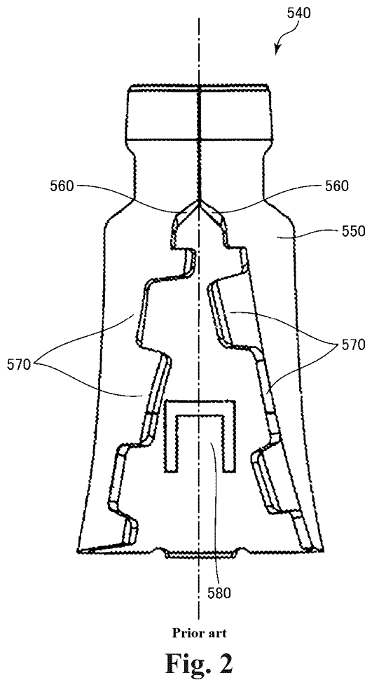

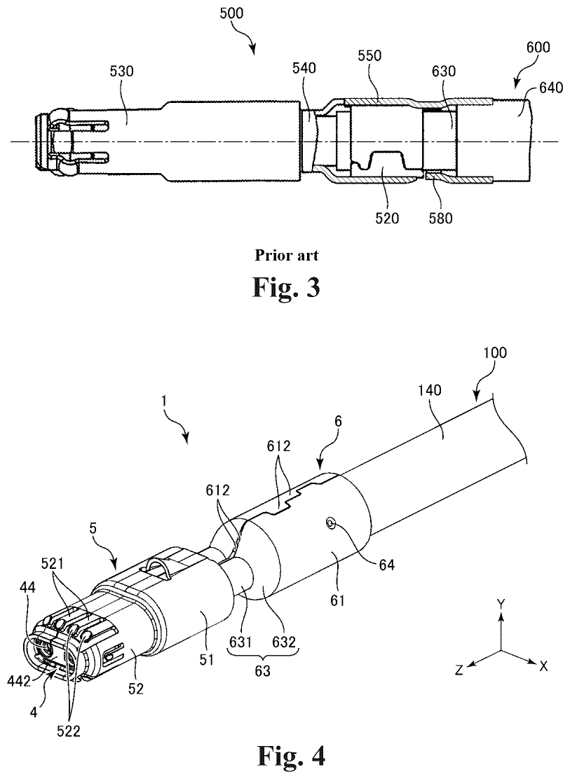

### DETAILED DESCRIPTION

Hereinafter, description will be given to an electrical connector of the present disclosure based on an embodiment shown in the accompanying drawings. In this regard, the drawings referenced in the following description are schematic views prepared for explaining the present disclosure. A dimension (such as a length, a width, and a thickness) of each component shown in the drawings is not necessarily identical to an actual dimension. Further, the same reference numbers are used throughout the drawings to refer to the same or like elements. In the following description, a positive direction of the Z axis in each figure may be referred to as a “tip side” or a “front side”, a negative direction of the Z axis in each figure may be referred to as a “base side” or a “rear side”, a positive direction of the Y axis in each figure may be referred to as an “upper side”, a negative direction of the Y axis in each figure may be referred to as a “lower side”, a positive direction of the X axis in each figure may be referred to as a “near side”, and a negative direction of the X axis in each figure may be referred to as a “far side”. In addition, the Z direction may be referred to as an “insertion and extraction direction of the electrical connector”, the Y direction may be referred to as a “height direction”, and the X direction may be referred to as a “width direction”.

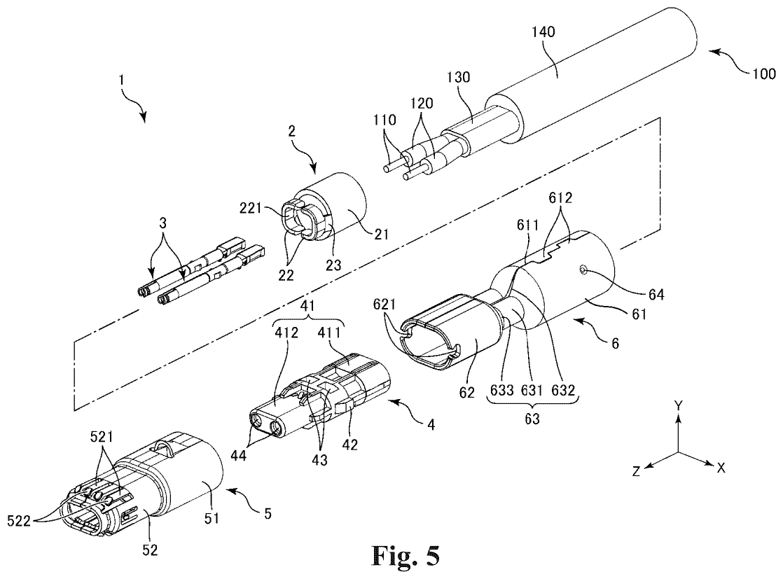

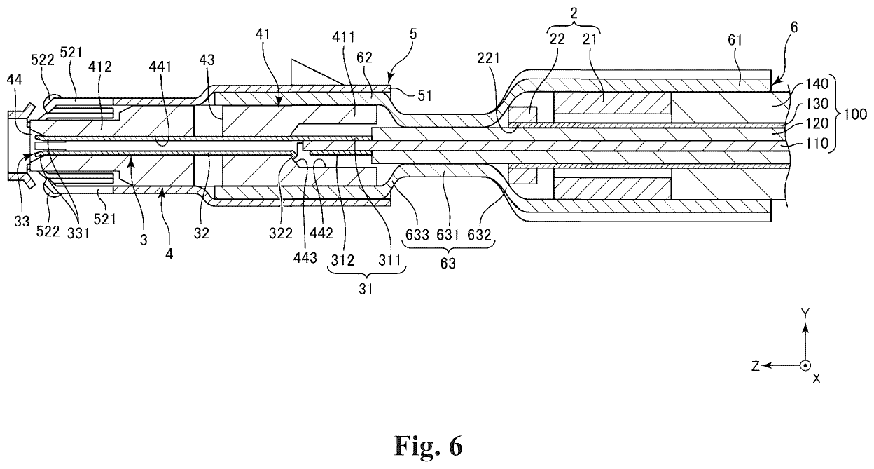

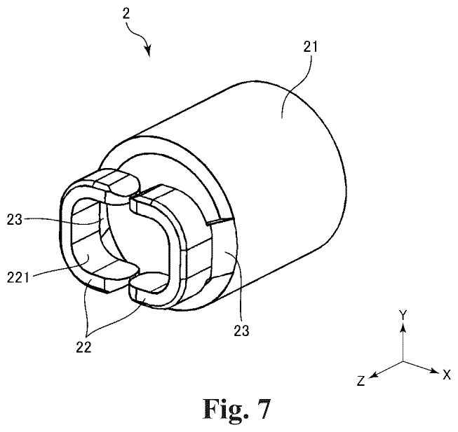

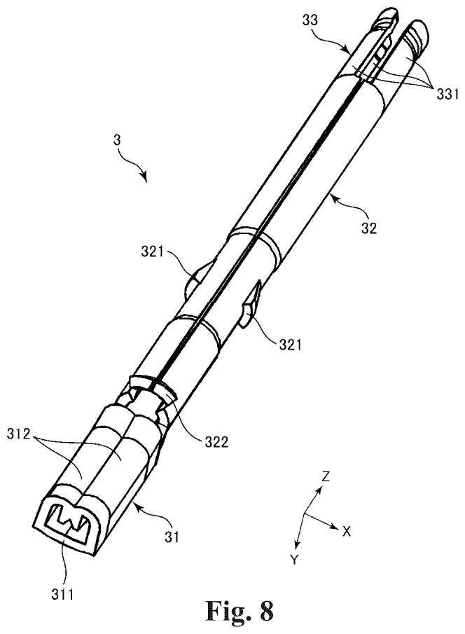

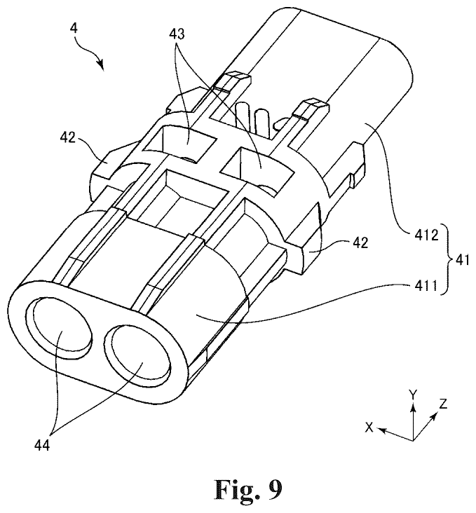

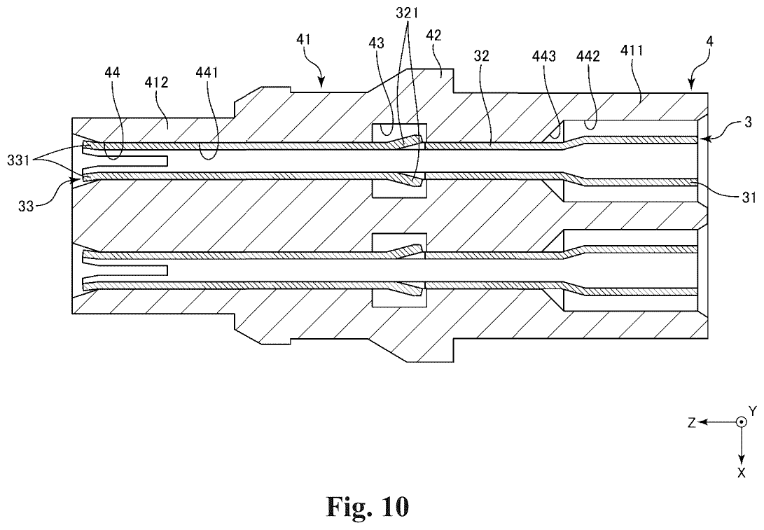

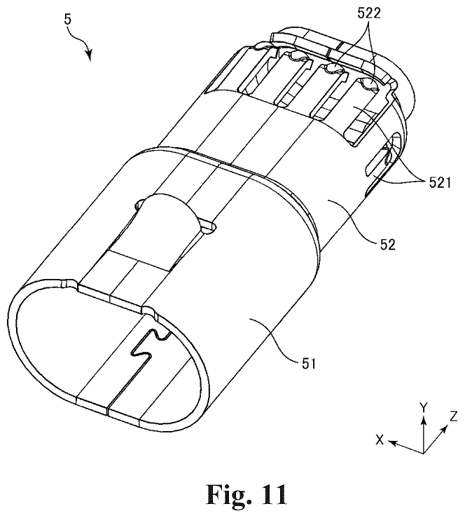

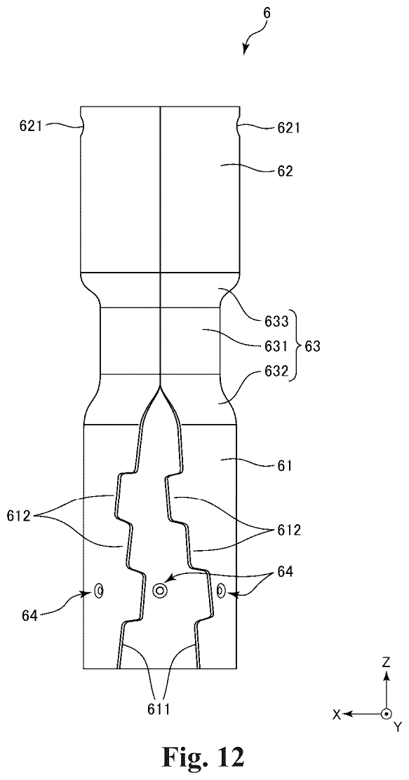

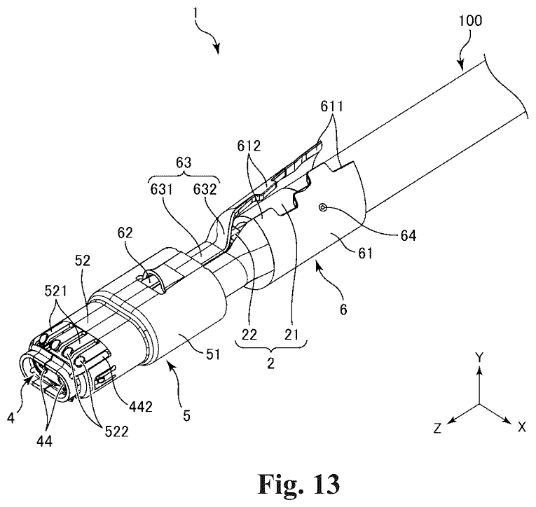

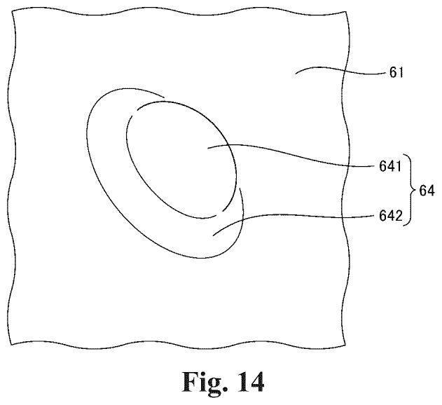

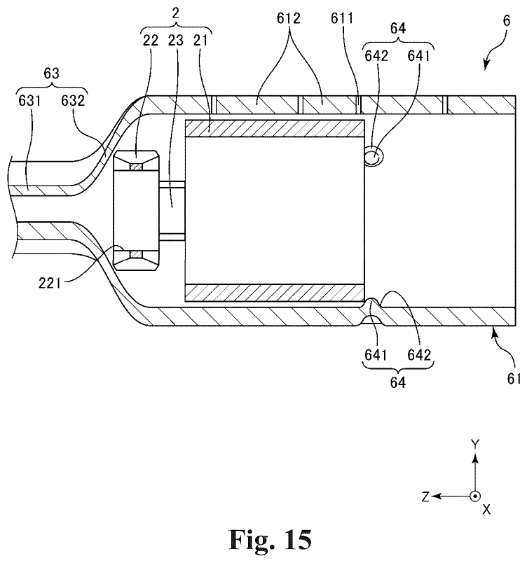

FIG. 4 is a perspective view showing the electrical connector of the present disclosure and a coaxial cable to which the electrical connector is connected. FIG. 5 is an exploded perspective view of the electrical connector and the coaxial cable shown in FIG. 4. FIG. 6 is a cross-sectional view of the electrical connector and the coaxial cable in a plane containing one of core wires of the coaxial cable. FIG. 7 is a perspective view of an inner crimping member shown in FIG. 5 viewed from another angle. FIG. 8 is a perspective view of a contact pin shown in FIG. 5 viewed from another angle. FIG. 9 is a perspective view of a housing shown in FIG. 5 viewed from another angle. FIG. 10 is a cross-sectional view for explaining holding of the contact pins in the housing. FIG. 11 is a perspective view of an outer contact shown in FIG. 5 viewed from another angle. FIG. 12 is a planar view showing the outer crimping member before being crimped onto the inner crimping member. FIG. 13 is a perspective view for explaining crimping of the outer crimping member onto the inner crimping member. FIG. 14 is a perspective view of a locking protrusion of the outer crimping member shown in FIG. 12. FIG. 15 is a cross-sectional view for explaining locking of the inner crimping member in the outer crimping member by the locking protrusion.

As shown in FIGS. 4 and 5, an electrical connector 1 of the present disclosure is a plug connector to be inserted into a mating connector (a receptacle connector) mounted on a circuit board provided in an arbitrary device and coupled with the mating connector. When the electrical connector 1 attached to one end portion of a coaxial cable 100 is inserted into the mating connector and the electrical connector 1 is coupled with the mating connector, an electrical connection between the coaxial cable 100 and the device is provided through the electrical connector 1 and the mating connector.

The coaxial cable 100 has a coaxial structure that includes a pair of core wires (center conductors) 110, a pair of inner insulator layers 120 respectively covering the pair of core wires 110 so as to be respectively concentric with the pair of core wires 110, an outer conductor layer (a braid layer) 130 covering the pair of inner insulator layers 120, and an outer insulator layer 140 further covering the outer conductor layer 130. Although this matter is omitted in FIGS. 4 and 5, a base end portion of the coaxial cable 100 is connected to a device that is different from the device including the circuit board. Thus, when the electrical connector 1 is coupled with the mating connector, it becomes possible to perform a signal communication between the two devices through the coaxial cable 100. The device including the circuit board is typically an ECU (Electronic Control Unit) for controlling operations of a vehicle. The other device to which the base end portion of the coaxial cable 100 is connected is typically an in-vehicle device, such as an in-vehicle network communication device used for an in-vehicle Ethernet or the like, a car navigation device, a car audio device, an in-vehicle camera device, an in-vehicle GPS device, an in-vehicle TV device, or an in-vehicle radio device. By coupling the electrical connector 1 and the mating connector with each other, it becomes possible to perform a high-speed signal communication between the in-vehicle device and the ECU through the two core wires (center conductors) 110. Although the electrical connector 1 is a 2-pin connector for providing a coaxial connection with the coaxial cable 100 containing the two core wires 110 in the illustrated embodiment, the electrical connector 1 may be a multi-pin connector (for example, 4-pin connector (a high-speed data (HSD) connector)) for providing coaxial connections with two or more coaxial cables 100. Hereinafter, the electrical connector 1 will be described assuming that the electrical connector 1 is the 2-pin connector for providing the coaxial connection with the coaxial cable 100 containing the two core wires 110.

As shown in FIG. 5, the electrical connector 1 includes an inner crimping member 2 to be crimped onto the outer conductor layer 130 of the coaxial cable 100, a pair of contact pins 3 to be respectively connected to the core wires 110 of the coaxial cable 100, an insulating housing 4 for holding the contact pins 3 therein, a cylindrical outer contact 5 for covering the housing 4, and an outer crimping member 6 integrated with the outer contact 5 and crimped onto the inner crimping member 2 from an outer side.

The inner crimping member 2 is a cylindrical member formed from a metallic material and should be crimped onto the outer conductor layer 130 of the coaxial cable 100. As shown in FIG. 7, the inner crimping member 2 includes a cylindrical support portion 21, a pair of crimping portions 22 located on the tip side of the support portion 21, and a pair of connection portions 23 for connecting between the support portion 21 and the pair of crimping portions 22. The support portion 21 is a cylindrical portion onto which the outer crimping member 6 is crimped from the outer side. A tip end surface and a base end surface of the support portion 21 are flat surfaces perpendicular to the Z direction. As shown in FIG. 6, in the assembled state of the electrical connector 1, an inner peripheral surface of the support portion 21 faces the outer conductor layer 130 of the coaxial cable 100 through a gap therebetween. Although the outer crimping member 6 is crimped onto the support portion 21 from the outer side, there is the gap between the outer conductor layer 130 and the inner peripheral surface of the support portion 21, and thereby a pressure for crimping the outer crimping member 6 is received by the support portion 21 and is not transmitted to the coaxial cable 100. Thus, it is possible to prevent deformation of the core wires 110 of the coaxial cable 100 caused by the pressure when the outer crimping member 6 is crimped onto the support portion 21, thereby preventing deterioration of signal transmission characteristics of the coaxial cable 100.

Referring back to FIG. 7, the pair of crimping portions 22 are U-shaped portions that face each other to define an opening 221 through which the coaxial cable 100 should be passed. A tip end surface and a base end surface of each of the pair of crimping portions 22 are flat surfaces perpendicular to the Z direction. The pair of crimping portions 22 are formed so that two end portions of each of the pair of U-shaped crimping portions 22 are directed toward the inner side and face each other with a gap therebetween. As shown in FIG. 6, the coaxial cable 100 is passed through the opening 221. In a state in which the coaxial cable 100 is passed through the opening 221, a swaging process in which the two end portions of each of the pair of crimping portions 22 are pressed toward the outer conductor layer 130 of the coaxial cable 100 is performed by using an appropriate tool such as crimping pliers, and thereby the pair of crimping portions 22 are crimped onto the outer conductor layer 130. As a result, the inner crimping member 2 is attached to the outer conductor layer 130. Each of the pair of connection portions 23 is a plate-like portion for connecting between the tip end surface of the support portion 21 and the base end surface of the corresponding crimping portion 22. Each of the pair of connection portions 23 extends obliquely inward from the base side toward the tip side. Further, an outer surface of each connection portion 23 is continuous with an outer peripheral surface of the support portion 21 and an outer peripheral surface of the corresponding crimping portion 22.

Referring back to FIG. 5, each of the pair of contact pins 3 is a cylindrical member formed from a conductive material such as a copper alloy and should be connected to the corresponding core wire 110 of the coaxial cable 100. Since the pair of contact pins 3 have the same configuration as each other, a configuration of one of the contact pins 3 will be described in detail as a representative. As shown in FIG. 8, the contact pin 3 includes a holding portion 31 for holding the core wire 110 of the coaxial cable 100 therein by a crimping method, a cylindrical portion 32 extending from a tip end portion of the holding portion 31 toward the tip side, and a guide portion 33 formed at a tip end of the cylindrical portion 32 to guide insertion of a corresponding contact pin of the mating connector.

The holding portion 31 includes a plate-like portion 311 linearly extending in the Z direction and a pair of wall portions 312 extending from the plate-like portion 311 toward the lower side (in the −Y direction) and pressing the core wire 110 of the coaxial cable 100 onto the plate-like portion 311. Although the pair of wall portions 312 are curved so that tip end portions of the wall portions 312 are directed toward the plate-like portion 311 in the illustrated aspect, the pair of wall portions 312 linearly extend from the plate-like portion 311 toward the lower side and face each other in parallel in a state before the contact pin 3 is connected to the core wire 110. The contact pin 3 is connected to the core wire 110 according to the following procedure. First, the core wire 110 is placed on the plate-like portion 311. Next, a swaging process is performed by using an appropriate tool such as crimping pliers. In this swaging process, the tip end portions of the pair of wall portions 312 linearly extending from the plate-like portion 311 are bent toward the core wire 110 so as to press the core wire 110 onto the plate-like portion 311. By such a procedure, the core wire 110 is securely held in the holding portion 31, and the contact pin 3 is connected to the core wire 110.

The cylindrical portion 32 is a portion for receiving the corresponding contact pin of the mating connector. The cylindrical portion 32 is formed so as to linearly extend from the tip end portion of the holding portion 31 toward the tip side. The cylindrical portion 32 includes a pair of spring portions 321 protruding from the cylindrical portion 32 toward the outer side and a positioning protrusion 322 protruding from an outer peripheral surface of a base end portion of the cylindrical portion 32 toward the lower side.

The pair of spring portions 321 are formed for providing a click feeling indicating that press-fitting of the contact pin 3 into the housing 4 is completed when the contact pin 3 is press-fitted into the housing 4 and preventing the contact pin 3 from being removed from the housing 4. Each of the pair of spring portions 321 has a tapered shape whose height gradually increases from the tip side toward the base side. Further, each of the pair of spring portions 321 is configured to be elastically deformed toward the inner side. When the contact pin 3 is press-fitted into the housing 4, the pair of spring portions 321 are gradually and elastically deformed toward the inner side according to the respective tapered shapes thereof. Thereafter, when the pair of spring portions 321 reach an after-mentioned engagement hole 43 (see FIGS. 9 and 10) of the housing 4, the pair of spring portions 321 elastically restore toward the outer side and engage with the engagement hole 43. This elastic restoration of the pair of spring portions 321 when the pair of spring portions 321 are engaged with the engagement hole 43 provides the click feeling. Further, since the pair of spring portions 321 are engaged with the engagement hole 43, it is possible to prevent the contact pin 3 from being removed from the housing 4.

Referring back to FIG. 8, the positioning protrusion 322 is formed for positioning the contact pin 3 in the housing 4. The positioning protrusion 322 extends from the base end portion of the cylindrical portion 32 toward the lower side. As shown in FIG. 6, when the press-fitting of the contact pin 3 into the housing 4 is completed, the positioning protrusion 322 abuts against an after-mentioned tapered portion 443 formed on an inner peripheral surface of the housing 4, and thereby the press-fitting of the contact pin 3 into the housing 4 is regulated. With this configuration, the contact pin 3 is positioned in the housing 4.

Referring back to FIG. 8, the guide portion 33 is a portion for guiding the insertion of the corresponding contact pin of the mating connector into the cylindrical portion 32. The guide portion 33 is constituted of three plate-like portions 331 protruding from a tip end surface of the cylindrical portion 32 toward the tip side with being spaced apart from each other. Since all of the three plate-like portions 331 have the same structure, a structure of one of the plate-like portions 331 will be described below in detail as a representative. The plate-like portion 331 protrudes from the tip end surface of the cylindrical portion 32 toward the tip side. A base end portion of the plate-like portion 331 is integrated with the tip end surface of the cylindrical portion 32, and a tip end portion of the plate-like portion 331 is a free end. Further, an outer surface and an inner surface of the base end portion of the plate-like portion 331 are respectively continuous with an outer peripheral surface and an inner peripheral surface of the cylindrical portion 32. Further, the tip end portion of the plate-like portion 331 is an inclined surface inclined toward the outer side. The corresponding contact pin of the mating connector slides on an inner surface of the plate-like portion 331, thereby guiding the insertion of the corresponding contact pin of the mating connector into the cylindrical portion 32. Further, the three plate-like portions 331 are formed on the tip end surface of the cylindrical portion 32 at equal angular intervals. The above-mentioned contact pin 3 is press-fitted into the housing 4 and held by the housing 4.

Referring back to FIG. 5, the housing 4 is a cylindrical member formed from an insulating material such as a resin material having elasticity. The housing 4 has a function of holding the contact pin 3 therein. As shown in FIGS. 9 and 10, the housing 4 includes a substantially ellipsoidal body portion 41, a pair of engagement protrusions 42 respectively protruding from X-direction side surfaces of the body portion 41 toward the outer side, the pair of engagement holes 43 linearly passing through the body portion 41 in the Y direction, and a pair of through-holes 44 formed so as to linearly pass through the body portion 41 in the Z direction. In FIG. 10, components other than the housing 4 and the pair of contact pins 3 are omitted in order to describe an internal structure of the housing 4 and the holding of the pair of contact pins 3 in the housing 4.

The body portion 41 is a substantially ellipsoidal cylindrical member flattened in the X direction. The body portion 41 includes a press-fitted portion 411 located on the base side and press-fitted into a contact portion 62 of the outer crimping member 6 and a tongue-shaped portion 412 protruding from the press-fitted portion 411 toward the tip side. The press-fitted portion 411 has an outer shape corresponding to a space defined by an inner peripheral surface of the contact portion 62. The press-fitted portion 411 is press-fitted into the contact portion 62 from the tip side, and thereby the housing 4 is held by the outer crimping member 6. The tongue-shaped portion 412 is an ellipsoidal cylindrical portion flattened in the X direction. The tongue-shaped portion 412 protrudes from the press-fitted portion 411 toward the tip side. An outer diameter of the tongue-shaped portion 412 in the X direction is smaller than an outer diameter of the press-fitted portion 411 in the X direction. An outer diameter of the tongue-shaped portion 412 in the Y direction is smaller than an outer diameter of the press-fitted portion 411 in the Y direction. As shown in FIG. 6, in the assembled state of the electrical connector 1, a base side portion of the press-fitted portion 411 is located in the contact portion 62, and the tongue-shaped portion 412 and a tip side portion of the press-fitted portion 411 protrude from the contact portion 62 toward the tip side.

Referring back to FIG. 9, the pair of engagement protrusions 42 are portions that respectively protrude from both X-direction side surfaces of the press-fitted portion 411 toward the outer side. A tip end surface of each of the pair of engagement protrusions 42 is an inclined surface whose protruding amount from the press-fitted portion 411 increases from the tip side toward the base side. On the other hand, a base end surface of each of the pair of engagement protrusions 42 is a flat surface perpendicular to the Z direction. When the press-fitted portion 411 is press-fitted into the contact portion 62 of the outer crimping member 6, the pair of engagement protrusions 42 are respectively inserted into a pair of engagement recesses 621 (see FIG. 5) of the contact portion 62. Further, the base end surface of each of the pair of engagement protrusions 42 abuts against a bottom surface (an end surface facing the tip side) of each of the pair of engagement recesses 621, thereby positioning the housing 4 with respect to the outer crimping member 6.

Referring back to FIG. 9, the pair of engagement holes 43 are rectangular holes that linearly pass through the press-fitted portion 411 in the Y direction with being spaced apart from each other. As shown in FIG. 10, the pair of engagement holes 43 respectively communicate with the pair of through-holes 44 in the press-fitted portion 411. When the contact pin 3 is press-fitted into the through-hole 44, the pair of spring portions 321 of the contact pin 3 elastically restore toward the outer side in the engagement hole 43, thereby providing the click feeling. Further, since the pair of spring portions 321 are engaged with the engagement hole 43, it is possible to prevent the contact pin 3 from being removed from the through-hole 44.

The pair of through-holes 44 are circular openings that linearly pass through the body portion 41 in the Z direction with being spaced apart from each other. As shown in FIG. 10, the pair of contact pins 3 are respectively press-fitted into the pair of through-holes 44. Each of the pair of through-holes 44 includes a small diameter portion 441 located on the tip side and communicating with the outside from a tip end surface of the tongue-shaped portion 412, a large diameter portion 442 located on the base side of the small diameter portion 441 and communicating with the outside from a base end surface of the press-fitted portion 411, and the tapered portion 443 connecting between the small diameter portion 441 and the large diameter portion 442.

The small diameter portion 441 is a cylindrical space linearly extending in the body portion 41 in the Z direction. A diameter of the small diameter portion 441 is substantially equal to an outer diameter of the cylindrical portion 32 of the contact pin 3. The large diameter portion 442 is a cylindrical space linearly extending from the small diameter portion 441 toward the base side. A diameter of the large diameter portion 442 is larger than the diameter of the small diameter portion 441. As shown in FIG. 10, the holding portion 31 of the contact pin 3 is located in the large diameter portion 442. The tapered portion 443 is a portion for connecting between the small diameter portion 441 and the large diameter portion 442. The tapered portion 443 has a tapered shape whose diameter gradually increases from the tip side toward the base side. A diameter of a tip end portion of the tapered portion 443 is equal to the diameter of the small diameter portion 441. A diameter of a base end portion of the tapered portion 443 is equal to the diameter of the large diameter portion 442. As shown in FIG. 6, when the contact pin 3 is press-fitted into the through-hole 44, the positioning protrusion 322 of the contact pin 3 abuts against the tapered portion 443, and thereby the press-fitting of the contact pin 3 into the through-hole 44 is regulated.

Referring back to FIG. 5, the outer contact 5 is a cylindrical member formed from a metallic material. The outer contact 5 serves as an outer conductor layer covering the housing 4. As shown in FIG. 11, the outer contact 5 includes a base end portion 51 covering the contact portion 62 of the outer crimping member 6 from the outer side and integrated with the contact portion 62 and a protruding portion 52 extending from a tip end portion of the base end portion 51 toward the tip side.

The base end portion 51 is an ellipsoidal cylindrical portion that covers the contact portion 62 of the outer crimping member 6 from the outer side. The base end portion 51 has a shape corresponding to an outer shape of the contact portion 62. As shown in FIG. 6, a base end portion of the press-fitted portion 411 of the housing 4 and the contact portion 62 are located in the base end portion 51. In a state in which the contact portion 62 is located in the base end portion 51, a swaging process in which the base end portion 51 is pressed onto the contact portion 62 from the outer side is performed, and thereby the base end portion 51 is crimped onto the contact portion 62. Further, the base end portion 51 and the contact portion 62 are welded together. As a result, the outer contact 5 and the outer crimping member 6 are integrated with each other.

Referring back to FIG. 11, the protruding portion 52 is an ellipsoidal cylindrical portion flattened in the X direction. The protruding portion 52 protrudes from the base end portion 51 toward the tip side. A diameter of the protruding portion 52 in the X direction is smaller than a diameter of the base end portion 51 in the X direction. A diameter of the protruding portion 52 in the Y direction is smaller than a diameter of the base end portion 51 in the Y direction. The protruding portion 52 includes a plurality of spring portions 521 formed on an outer peripheral surface of a tip end side portion of the protruding portion 52, and contact portions 522 respectively formed on tip end portions of the plurality of spring portions 521 and configured to contact the outer contact of the mating connector.

Each of the plurality of spring portions 521 is a plate-like portion formed by cutting out a part of an outer peripheral surface of the protruding portion 52. Further, the plurality of spring portions 521 are formed on the outer peripheral surface of the protruding portion 52 with being spaced apart from each other. The plurality of spring portions 521 are formed to reduce force required for mating the outer contact 5 with the corresponding outer contact of the mating connector. Since all of the plurality of spring portions 521 have the same structure, a structure of one of the spring portions 521 will be described below in detail as a representative. The spring portion 521 has one end portion integrated with the protruding portion 52 and functioning as a fixed end, and another end portion functioning as a free end. The other end portion of the spring portion 521 is curved toward the inner side.

Each of the contact portions 522 is a portion configured to contact the corresponding outer contact of the mating connector. The contact portion 522 is formed on an outer peripheral surface of the other end portion (the free end) of each of the plurality of spring portions 521 so as to protrude toward the outer side. When the electrical connector 1 is coupled with the mating connector, each contact portion 522 contacts the corresponding outer contact of the mating connector. At this time, since the plurality of spring portions 521 are elastically deformed toward the inner side, it is possible to reduce the force required to mate the outer contact 5 with the corresponding outer contact of the mating connector.

Referring back to FIG. 5, the outer crimping member 6 is a cylindrical member formed from a metallic material. The outer crimping member 6 is used for attaching the outer contact 5 to the coaxial cable 100 by being integrated with the base end portion 51 of the outer contact 5 and crimped onto the inner crimping member 2 from the outer side. FIG. 12 shows the outer crimping member 6 before being crimped onto the support portion 21 of the inner crimping member 2. As shown in FIG. 12, the outer crimping member 6 includes a cylindrical crimping portion 61 crimped onto the support portion 21 of the inner crimping member 2 from the outer side, the cylindrical contact portion 62 located on the tip side of the crimping portion 61, a cylindrical connection portion 63 connecting between the crimping portion 61 and the contact portion 62, and three locking protrusions 64 protruding from an inner peripheral surface of the crimping portion 61 toward the inner side.

The crimping portion 61 is a cylindrical portion crimped onto the support portion 21 of the inner crimping member 2 from the outer side. The crimping portion 61 includes a pair of opposite end surfaces 611 formed on an upper surface of the crimping portion 61 so that a separation distance between the pair of opposite end surfaces 611 increases from the tip side toward the base side, and concave-convex structures 612 respectively formed on the pair of opposite end surfaces 611 so as to complementarily engage with each other. The pair of opposite end surfaces 611 define an opening whose width in the X direction increases from the tip side to the base side. As shown in FIG. 13, the pair of contact pins 3 are respectively crimped onto the pair of core wires 110 of the coaxial cable 100, the housing 4 is press-fitted into the contact portion 62, and the outer contact 5 is integrated with the contact portion 62. In this state, the coaxial cable 100 onto which the inner crimping member 2 is crimped is inserted into the crimping portion 61 from the base side. After the pair of contact pins 3 are respectively press-fitted into the pair of through-holes 44 of the housing 4, a swaging process is performed for pressing the pair of opposite end surfaces 611 onto the support portion 21 of the inner crimping member 2, and thereby the outer crimping member 6 is crimped onto the support portion 21.

Referring back to FIG. 12, the contact portion 62 is an ellipsoidal cylindrical portion flattened in the X direction and located on the tip side of the crimping portion 61. As shown in FIG. 6, in the assembled state of the electrical connector 1, the contact portion 62 holds the base side portion of the press-fitted portion 411 of the housing 4 therein, and the contact portion 62 is covered by the base end portion 51 of the outer contact 5 from the outer side. Thus, the contact portion 62 is located between the press-fitted portion 411 of the housing 4 and the base end portion 51. As described above, the press-fitted portion 411 is press-fitted into the contact portion 62 from the tip side. Further, the contact portion 62 is inserted into the base end portion 51 of the outer contact 5 from the base side, and the contact portion 62 and the base end portion 51 are integrated by the swaging process to the base end portion 51 and the welding process between the base end portion 51 and the contact portion 62.

The contact portion 62 includes the pair of engagement recesses 621 formed on a tip end surface of the contact portion 62. The pair of engagement recesses 621 are rectangular recesses respectively formed on both end portions of the tip end surface of the contact portion 62 in the X direction and linearly extending from the tip side to the base side. The press-fitted portion 411 of the housing 4 is press-fitted into the contact portion 62 from the tip side so that the pair of engagement protrusions 42 of the housing 4 are respectively inserted into the pair of engagement recesses 621. The pair of engagement protrusions 42 respectively abut against the bottom surfaces (the end surfaces facing the tip side) of the pair of engagement recesses 621, and thereby the press-fitting of the press-fitted portion 411 into the contact portion 62 is regulated.

The connection portion 63 is a cylindrical portion connecting between the crimping portion 61 and the contact portion 62. The connection portion 63 includes a cylindrical portion 631 linearly extending in the Z direction, a base side tapered portion 632 connecting between a base end portion of the cylindrical portion 631 and a tip end portion of the crimping portion 61, and a tip side tapered portion 633 connecting between a tip end portion of the cylindrical portion 631 and a base end portion of the contact portion 62. The cylindrical portion 631 is an ellipsoidal cylindrical member flattened in the X direction and linearly extending in the Z direction. An inner diameter of the cylindrical portion 631 in the X direction is smaller than inner diameters of the crimping portion 61 and the contact portion 62 in the X direction. An inner diameter of the cylindrical portion 631 in the Y direction is smaller than inner diameters of the crimping portion 61 and the contact portion 62 in the Y direction. Similarly, an outer diameter of the cylindrical portion 631 in the X direction is smaller than outer diameters of the crimping portion 61 and the contact portion 62 in the X direction. An outer diameter of the cylindrical portion 631 in the Y direction is smaller than outer diameters of the crimping portion 61 and the contact portion 62 in the Y direction.

The base side tapered portion 632 is an ellipsoidal cylindrical portion flattened in the X direction. The base side tapered portion 632 connects between the base end portion of the cylindrical portion 631 and the tip end portion of the crimping portion 61. The base side tapered portion 632 has a tapered shape whose inner diameter and outer diameter gradually decrease from the base side toward the tip side. The tip side tapered portion 633 is an ellipsoidal cylindrical portion flattened in the X direction. The tip side tapered portion 633 connects between the tip end portion of the cylindrical portion 631 and the base end portion of the contact portion 62. The tip side tapered portion 633 has a tapered shape whose inner diameter and outer diameter gradually increase from the base side toward the tip side. As shown in FIG. 6, in the assembled state of the electrical connector 1, an inner peripheral surface of the cylindrical portion 631 covers the inner insulator layer 120 of the coaxial cable 100 from the outer side. Further, the pair of crimping portions 22 of the inner crimping member 2 abut against an inner peripheral surface of the base side tapered portion 632, and thereby the inner crimping member 2 is positioned in the outer crimping member 6.

Referring back to FIG. 12, each of the three locking protrusions 64 is a protrusion having a circular dome shape protruding from the inner peripheral surface of the crimping portion 61 toward the inner side. The three locking protrusions 64 are formed on the inner peripheral surface of the crimping portion 61 at equal angular intervals. Two of the three locking protrusions 64 are formed on an upper portion of the inner peripheral surface of the crimping portion 61, and remaining one of the three locking protrusions 64 is formed on a lower portion of the inner peripheral surface of the crimping portion 61. Each of the three locking protrusions 64 is formed by performing a pressing process in which an arbitrary tool such as a pin is pressed against an outer peripheral surface of the crimping portion 61 from the outer side. Further, since the three locking protrusions 64 are formed by such a pressing process, three recesses respectively corresponding to the three locking protrusions 64 are formed in areas of the outer peripheral surface of the crimping portion 61 where the pressing process is applied. Since the three locking protrusions 64 have the same configuration as each other, a configuration of one of the locking protrusions 64 will be described in detail as a representative.

FIG. 14 shows the locking protrusion 64 formed on the inner peripheral surface of the crimping portion 61. The locking protrusion 64 includes a circular dome portion 641 protruding from the inner peripheral surface of the crimping portion 61 toward the inner side, and an annular leg portion 642 surrounding an outer edge of the dome portion 641 and connecting between the dome portion 641 and the inner peripheral surface of the crimping portion 61. The dome portion 641 has a circular dome shape whose inwardly protruding amount from the inner peripheral surface of the crimping portion 61 gradually decreases from a center portion of the dome portion 641 toward the outer side. The outer edge of the dome portion 641 is completely surrounded by the leg portion 642. Thus, no discontinuous area such as a slit or an opening exists between the outer edge of the dome portion 641 and the leg portion 642, and the outer edge of the dome portion 641 is completely continuous with the leg portion 642.

The leg portion 642 is an annular portion connecting between the dome portion 641 and the inner peripheral surface of the crimping portion 61. The leg portion 642 has a skirt shape whose inwardly protruding amount gradually increases from the outer side toward a center of the leg portion 642. An upper end portion of the leg portion 642 is continuously connected to the outer edge of the dome portion 641. A lower end portion of the leg portion 642 is continuously connected to the inner peripheral surface of the crimping portion 61. An entire area of the lower end portion of the leg portion 642 is continuous with the inner peripheral surface of the crimping portion 61. Thus, no discontinuous area such as a slit or an opening exists between the lower end portion of the leg portion 642 and the inner peripheral surface of the crimping portion 61, and the entire area of the leg portion 642 is continuous with the inner peripheral surface of the crimping portion 61.

FIG. 15 shows locking of the inner crimping member 2 in the crimping portion 61 by the locking protrusions 64. In FIG. 15, components other than the inner crimping member 2 and the outer crimping member 6 are omitted. As shown in FIG. 15, the locking protrusion 64 is formed so as to be located at a position and has a height (the inwardly protruding amount from the inner peripheral surface of the crimping portion 61) for allowing the locking protrusion 64 to contact the base end surface of the support portion 21 from the base side when the crimping portion 61 is crimped onto the support portion 21 from the outer side. Thus, the locking protrusion 64 is formed on the inner peripheral surface of the crimping portion 61 for allowing the inner crimping member 2 to be locked in the crimping portion 61 from the base side. In a state in which the crimping portion 61 is crimped onto the support portion 21 of the inner crimping member 2 from the outer side, the three locking protrusions 64 contact the base end surface of the support portion 21 from the base side. With this configuration, in the assembled state of the electrical connector 1, the three locking protrusions 64 prevent the base end surface of the support portion 21 from being shifted toward the base side even if a pulling operation toward the base side is applied to the coaxial cable 100. As a result, it is possible to prevent the coaxial cable 100 from being removed from the electrical connector 1 toward the base side.

Further, the three locking protrusions 64 may be welded to the base end surface of the support portion 21, and thereby the three locking protrusions 64 and the support portion 21 may be integrated with each other. Typically, the three locking protrusions 64 and the base end surface of the support portion 21 are welded together by laser welding or spot welding. By integrating the three locking protrusions 64 and the support portion 21 with each other through the welding, a pull-out strength of the electrical connector 1 against the pulling operation applied to the coaxial cable 100 can be improved.

As described above, since each locking protrusion 64 has the circular dome shape, each locking protrusion 64 does not have any edge portion that comes into contact with the support portion 21 of the inner crimping member 2. Thus, when the coaxial cable 100 onto which the inner crimping member 2 is crimped is inserted into the outer crimping member 6, each locking protrusion 64 is not shaved by the support portion 21. Thus, it is possible to prevent generation of metal shavings inside the outer crimping member 6, thereby improving connection reliability of the electrical connector 1.

Further, when the coaxial cable 100 onto which the inner crimping member 2 is crimped is inserted into the outer crimping member 6, the two of the three locking protrusions 64 located on the upper side (+Y direction side) do not contact the inner crimping member 2. Thus, permanent deformation (permanent setting) of the two locking protrusions 64 does not occur. Further, when the coaxial cable 100 is inserted into the outer crimping member 6, the one of the three locking protrusions 64 located on the lower side (−Y direction side) contacts the inner crimping member 2 and is elastically deformed toward the outer side. However, load applied when the one locking protrusion 64 is elastically deformed toward the outer side is distributed substantially uniformly over an entire area of the leg portion 642 and thus the load is not concentrated at any particular location. Thus, permanent deformation (permanent setting) of the one locking protrusion 64 located on the lower side does not occur. As a result, a decrease in a contact area between each locking protrusion 64 and the base end surface of the support portion 21 does not occur, thereby improving the pull-out strength of the electrical connector 1 against the pulling operation applied to the coaxial cable 100.

Although the outer crimping member 6 includes the three locking protrusions 64 in the illustrated aspect, the present disclosure is not limited thereto. The outer crimping member 6 is only required to include at least one locking protrusion 64 and to be capable of locking the base end surface of the support portion 21 from the base side with the one locking protrusion 64. For example, the scope of the present disclosure also involves an aspect in which the outer crimping member 6 includes two locking protrusions 64, four or more locking protrusions 64 formed on the inner peripheral surface of the crimping portion 61 at equal angular intervals.

Although the three locking protrusions 64 are formed on the inner peripheral surface of the crimping portion 61 by performing the pressing process on the outer peripheral surface of the crimping portion 61 before the coaxial cable 100 is inserted into the outer crimping member 6 and the outer crimping member 6 is crimped onto the inner crimping member 2 in the above description, the present disclosure is not limited thereto. When the outer crimping member 6 is crimped onto the inner crimping member 2, it is not necessary that the three locking protrusions 64 have already been formed on the inner peripheral surface of the crimping portion 61. In this case, when the outer crimping member 6 is crimped onto the inner crimping member 2 or after the outer crimping member 6 has been crimped onto the inner crimping member 2, the pressing process is performed on the outer peripheral surface of the crimping portion 61 to form the three locking protrusions 64 on the inner peripheral surface of the crimping portion 61, and thereby the base end surface of the support portion 21 is locked by the three locking protrusions 64 from the base side.

The electrical connector 1 including the components described above should be attached to the end portion of the coaxial cable 100 by the following exemplary procedure. First, the housing 4 is press-fitted into the contact portion 62 of the outer crimping member 6 from the tip side. Specifically, the press-fitted portion 411 of the housing 4 is press-fitted into the contact portion 62 from the tip side in a posture such that the pair of engagement protrusions 42 of the housing 4 are respectively inserted into the pair of engagement recesses 621 of the contact portion 62. When the pair of engagement protrusions 42 abut against the bottom surfaces (the end surfaces facing the tip side) of the pair of engagement recesses 621, the press-fitting of the housing 4 into the outer crimping member 6 is completed.

Next, the contact portion 62 of the outer crimping member 6 is inserted into the outer contact 5 from the base side. Specifically, the tongue-shaped portion 412 protruding from the contact portion 62 toward the tip side is inserted into the base end portion 51 of the outer contact 5 from the base side. As shown in FIG. 6, when the contact portion 62 abuts against the inner peripheral surface of the outer contact 5 from the base side, the insertion of the contact portion 62 into the outer contact 5 is completed. Next, the swaging process is applied to the base end portion 51 for pressing the base end portion 51 onto the contact portion 62, and thereby the base end portion 51 is crimped onto the contact portion 62. Further, the base end portion 51 and the contact portion 62 are welded together. As a result, the outer contact 5 and the outer crimping member 6 are integrated with each other. Although the outer crimping member 6 is integrated with the outer contact 5 by the crimping and the welding in the above description, the present disclosure is not limited thereto. The outer crimping member 6 may be integrated with the outer contact 5 by one of the crimping and the welding.

Next, a stripping process is performed on the coaxial cable 100 to expose the pair of core wires 110, the pair of inner insulator layers 120, and the outer conductor layer 130 at the end portion of the coaxial cable 100 by respective required lengths. Next, the inner crimping member 2 is attached to the coaxial cable 100. Specifically, the coaxial cable 100 is passed through the support portion 21 of the inner crimping member 2 and the opening 221 from the base side. In a state in which the opening 221 faces the outer conductor layer 130 of the coaxial cable 100, the swaging process in which the two end portions of each of the pair of crimping portions 22 are pressed onto the outer conductor layer 130 is performed by using the appropriate tool such as crimping pliers to crimp the pair of crimping portions 22 onto the outer conductor layer 130.

Next, the pair of contact pins 3 are respectively crimped onto the pair of core wires 110. Specifically, the pair of core wires 110 of the coaxial cable 100 exposed by the stripping process are respectively placed onto the plate-like portions 311 of the holding portions 31 of the pair of contact pins 3. As described above, in the state before the contact pin 3 is connected to the core wire 110, the pair of wall portions 312 linearly extend from the plate-like portion 311 toward the lower side. By performing the swaging process in which the tip end portions of the pair of wall portions 312 of each contact pin 3 are bent to press the core wire 110 onto the plate-like portion 311 using an appropriate tool such as crimping pliers, the pair of contact pins 3 are respectively crimped onto the pair of core wires 110.

Next, the pair of contact pins 3 are inserted into the crimping portion 61 of the outer crimping member 6 from the base side and are respectively press-fitted into the pair of through-holes 44 of the housing 4. The pair of spring portions 321 of each of the pair of contact pins 3 elastically restore in the engagement hole 43 of the housing 4, and the positioning protrusion 322 of each of the pair of contact pins 3 abuts against the tapered portion 443 of the housing 4. Further, the pair of crimping portions 22 of the inner crimping member 2 abut against the inner peripheral surface of the base side tapered portion 632 of the outer crimping member 6. As a result, the press-fitting of the pair of contact pins 3 into the pair of through-holes 44 of the housing 4 is completed. FIG. 13 shows the electrical connector 1 and the coaxial cable 100 in this state.

Next, the swaging process, in which the pair of opposite end surfaces 611 are closed and pressed onto the support portion 21 of the inner crimping member 2, is performed on the crimping portion 61 of the outer crimping member 6, so that the crimping portion 61 is crimped onto the support portion 21 from the outer side. Further, in this state, the pair of concave-convex structures 612 respectively formed on the pair of opposite end surfaces 611 are complementarily engaged with each other and locked. As a result, the outer contact 5 is attached to the coaxial cable 100. In the case that the three locking protrusions 64 are not formed on the inner peripheral surface of the crimping portion 61 when the crimping portion 61 is crimped onto the support portion 21, the pressing process is performed on the outer peripheral surface of the crimping portion 61 during crimping the crimping portion 61 onto the support portion 21 or after the crimping portion 61 has been crimped onto the support portion 21 to form the three locking protrusions 64 on the inner peripheral surface of the crimping portion 61. As shown in FIG. 15, the three locking protrusions 64 of the outer crimping member 6 are in contact with the base end surface of the support portion 21 of the inner crimping member 2 from the base side in this state.

Next, the laser welding or the spot welding is performed between the three locking protrusions 64 and the base end surface of the support portion 21, and thus the three locking protrusions 64 are welded to the base end surface of the support portion 21. Thus, the three locking protrusions 64 and the base end surface of the support portion 21 are integrated with each other. The electrical connector 1 is attached to the end portion of the coaxial cable 100 by the above procedure.

Although the electrical connector according to the embodiment of the present disclosure has been described with reference to the illustrated aspect, the present disclosure is not limited thereto. Each configuration of the present disclosure can be replaced with an arbitrary configuration capable of performing the same function, or an arbitrary configuration can be added to each configuration of the present disclosure.

A person having ordinary skills in the art and the technique pertaining to the present disclosure may modify the configuration of the electrical connector of the present disclosure described above without meaningfully departing from the principle, the spirit and the scope of the present disclosure and the electrical connector having the modified configuration is also involved in the scope of the present disclosure.

In addition, the number and types of the components of the electrical connector shown in the drawings are merely illustrative examples and the present disclosure is not necessarily limited thereto. An aspect in which any component is added or combined or any component is omitted without departing from the principle and intent of the present disclosure is also involved within the scope of the present disclosure.

1. An electrical connector to be coupled with a coaxial cable including a core wire, an inner insulator layer covering the core wire, an outer conductor layer covering the inner insulator layer, and an outer insulator layer covering the outer conductor layer, the electrical connector comprising:
a contact pin to be connected to the core wire of the coaxial cable;
an insulating housing for holding the contact pin therein;
a cylindrical outer contact for covering the housing;
an inner crimping member to be crimped onto the outer conductor layer of the coaxial cable; and
an outer crimping member integrated with the outer contact and crimped onto the inner crimping member from an outer side,
wherein the outer crimping member includes:
a cylindrical crimping portion crimped onto the inner crimping member from the outer side, and
a locking protrusion protruding from an inner peripheral surface of the crimping portion toward an inner side, and
wherein the locking protrusion of the outer crimping member is in contact with a base end surface of the inner crimping member from a base side.

2. The electrical connector as claimed in claim 1, wherein the locking protrusion of the outer crimping member includes:
a dome portion protruding from the inner peripheral surface of the crimping portion toward the inner side, and
an annular leg portion surrounding an outer edge of the dome portion and connecting between the dome portion and the inner peripheral surface of the crimping portion.

3. The electrical connector as claimed in claim 2, wherein the leg portion of the locking protrusion of the outer crimping member includes:
an upper end portion that is continuous with the outer edge of the dome portion, and
a lower end portion that is continuous with the inner peripheral surface of the crimping portion, and
wherein an entire area of the lower end portion of the leg portion is continuous with the inner peripheral surface of the crimping portion.

4. The electrical connector as claimed in claim 1, wherein the locking protrusion of the outer crimping member is welded to the base end surface of the inner crimping member.

5. The electrical connector as claimed in claim 1, wherein the inner crimping member includes:
a crimping portion to be crimped onto the outer conductor layer of the coaxial cable, and
a cylindrical support portion located on the base side of the crimping portion and onto which the crimping portion of the outer crimping member is crimped from the outer side, and
wherein the locking protrusion of the outer crimping member is in contact with a base end surface of the support portion of the inner crimping member.

6. The electrical connector as claimed in claim 1, wherein the outer crimping member further includes:
a cylindrical contact portion containing the housing therein and contained in the outer contact, and
a cylindrical connection portion connecting between the crimping portion and the contact portion, and
wherein the outer contact is crimped or welded to the contact portion of the outer crimping member, and thereby the outer contact and the outer crimping member are integrated with each other.

7. The electrical connector as claimed in claim 6, wherein the connection portion of the outer crimping member is configured to cover the inner insulator layer of the coaxial cable from the outer side.

8. The electrical connector as claimed in claim 1, wherein each of the inner crimping member and the outer crimping member is formed from a metallic material.
